(19) United States
(12) Patent Application Publication
(10) Pub. No.: US 2011/0103647 A1
(43) Pub. Date: May 5, 2011

(54) Device and Method for Classifying Vehicles

(76) Inventors: Alexander Leopold, Wien (AT); Oliver Nagy, Wien (AT)

(21) Appl. No.: 12/896,813

(22) Filed: Oct. 1, 2010

(30) Foreign Application Priority Data
Oct. 1, 2009 (EP) 09 450 190.5

(51) Int. Cl. G06K 9/00; H04N 7/18; G06K 9/46

(52) U.S. Cl. 382/103; 348/143; 382/203; 348/E07.085

(57) ABSTRACT

Device for classifying objects, in particular vehicles, on a roadway, with a sensor, which operates according to the light-section procedure and is directed onto the roadway to detect the surface contour of an object, and an evaluation unit connected to the sensor that classifies the object on the basis of the detected surface contour.

### CROSS-REFERENCE TO RELATED APPLICATION(S)

This application claims priority to European Patent Application No. 09 450 190.5, filed on Oct. 1, 2009, the contents of which are hereby expressly incorporated by reference.

### FIELD OF THE INVENTION

The present invention relates to devices and methods for classifying objects, in particular vehicles, on a roadway.

### BACKGROUND

The classification of objects on roadways is of great importance for road toll and parking fee systems to be able to form class-dependent tariff models. A wide variety of designs are currently used for the classification of vehicles, such as induction loops embedded into the roadway, light barriers on the edge of the roadway or by means of radar or laser scanners mounted above the roadway. The first-mentioned can merely detect the size of vehicles and the last-mentioned, while they detect the entire surface contour of the vehicles as 3D relief, are technically complicated and therefore costly.

### SUMMARY

The present invention provides methods and devices for classification of objects, which are simpler and less expensive than the known solutions.

In a first aspect of the invention, a device of the aforementioned type is distinguished by a sensor, which operates according to the light-section procedure and is directed onto the roadway to detect the surface contour of an object, and an evaluation unit connected to the sensor that classifies the object on the basis of the detected surface contour.

In this way, the light-section procedure known in the art is used for the first time for the classification of objects on roadways, in particular vehicles. Light-section sensors project structured light, e.g. a single bar of light (“fan” of light or “line” of light), a plurality of parallel bars of light (“fringes” of light, so-called “fringe projection”) or even a complete grid of light at a first angle onto an object to be detected, and record the object with the structure projected thereon from an angle differing from the direction of projection, as a result of which the surface contour of the object can be determined from the distortions of the structure in the recorded image. The use of the light-section procedure for the classification of vehicles has the advantage that it requires a substantially lower computing effort for evaluation of the image than laser scanner procedures, since only individual bars of light or grid of light points have to be detected in the camera image and evaluated. Consequently, the sensor comprises a light pattern projector, which projects a pattern of light, preferably a grid of light, from a first location onto the roadway, and a camera, which records the projected pattern of light from a second location and determines the surface contour from distortions thereof, as is known in the art.

The embodiments of the invention are distinguished in that the light pattern projector additionally projects a light marking, which the camera also records. The light marking is preferably an inscription and/or a machine-readable code, preferably a bar code. The evaluation of the camera images can be made considerably easier as a result. For example, the light marking can identify individual bars of light of the light pattern to facilitate their automatic detection in the camera image; the light marking can also be integrated into the light pattern or its lines for this purpose. On the other hand, in a particularly advantageous manner the light marking can also be used to provide proof in traffic monitoring and control, e.g. if it indicates the location and time of recording of the camera image. The location and time of a traffic offence can then be “projected” into the recorded image, which has high evidential weight for the image. Both a human-readable inscription and a corresponding machine-readable code that contains such data are suitable for this.

In a further embodiment of the invention, the sensor has at least two light pattern projectors at different first locations to prevent shading on the object. It is understood that the camera and evaluation unit are designed accordingly to distinguish between the patterns of light originating from the individual light pattern projectors in the image, e.g. by different types of coding (marking) of the patterns of light, using different wavelengths for the patterns of light, operating the light pattern projectors in time-division multiplex operation etc.

A combination of code and line of light projection such as a Morse code integrated into the line, for instance, are also highly suitable. This integrated coding of the lines allows a distinction to be made between several projected lines—possibly from different light sources—and the initial system configuration or calibration is thus substantially simplified. For example, a dot-dash line can also be projected, in which the dash spacing or length contains the code. The generation of such lines is very simple to achieve using diaphragms connected after the light sources.

Each of the light pattern projectors can be of any desired type known in the art, in principle. It is particularly advantageous if the light pattern projector is a laser or light-emitting diode emitter, as a result of which high luminances can be achieved.

In some embodiments, existing traffic monitoring cameras can also be used for the camera of the sensor. This simplifies the assembly of such a system as part of existing traffic monitoring systems.

Other objects, e.g. pedestrians, can also be detected on the roadway and classified. Another embodiment may be a vehicle or pedestrian traffic light control system supplementing this.

In a further aspect, the invention provides an assembly for checking the identity of vehicles that supplements the outlined classification devices and is distinguished by a classification device of the type proposed here to obtain classification data of a vehicle; a device for license plate detection on vehicles to obtain license plate data of a vehicle; a data bank for linking the classification and license plate data to identity data of a vehicle; and an evaluation unit, which displays two vehicles as identical if their identity data are the same.

The identity data represent a type of fingerprint of a vehicle, with which it can be checked, for example, whether the license plate of the vehicle has been inadmissibly replaced or an inadmissible type of vehicle is being run with a specific license plate etc.

In some embodiments, the classification device and the license plate detection device use a joint camera. As a result, the identity check is performed using the same hardware as the vehicle classification and special software is primarily required in the evaluation unit for the automatic license plate recognition.

The invention monitors the entrance and exit of a car park and displays when the identity data of an exiting vehicle differ from the identity data stored in the data bank of a vehicle with the same license plate data which entered previously. This can provide a theft security system for car parks, e.g. in multistory car parks, which emits an alai in when license plates are being exchanged, to prevent a vehicle from being stolen under a different license plate.

In a further aspect the invention provides a method for classifying objects, in particular vehicles, on a roadway comprising: projecting a pattern of light, such as, a grid of light, from a first location onto the roadway; recording the projected pattern of light from a second location to determine the surface contour of an object from distortions of the pattern of light; and classifying the object on the basis of the detected surface contour.

Finally, the invention also provides a method for checking the identity of vehicles comprising: conducting the classification method proposed here on a first appearing vehicle to obtain classification data of the vehicle; detecting license plate data of the vehicle and linking the classification and license plate data to obtain identity data of the first appearing vehicle; conducting the classification method proposed here on a second appearing vehicle to obtain classification data of the vehicle; detecting license plate data of the vehicle and linking the classification and license plate data to obtain identity data of the second appearing vehicle; and recognising the first appearing vehicle and the second appearing vehicle as identical if their identity data are the same.

### BRIEF DESCRIPTION OF THE DRAWINGS

The invention shall be explained in more detail below on the basis of exemplary embodiments shown in the attached drawings.

FIG. 1 is a schematic perspective view of the device showing the method of the invention for classifying vehicles on a roadway, according to some embodiments of the present invention;

FIGS. 2 to 4 show different variants of patterns of light that can be projected onto a vehicle for the purpose of classification using the light-section procedure; and

FIG. 5 is a schematic perspective view of an assembly according to some embodiment of the present invention for checking the identity of vehicles.

### DETAILED DESCRIPTION

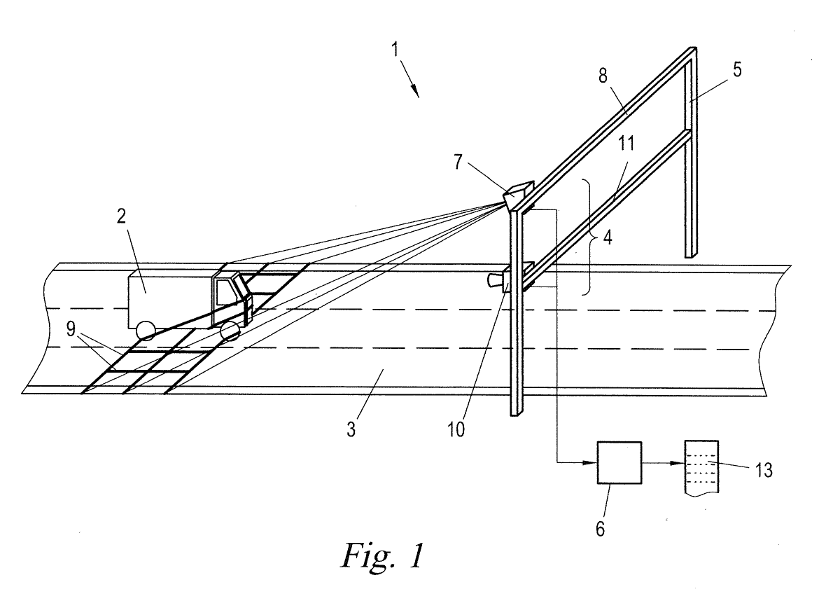

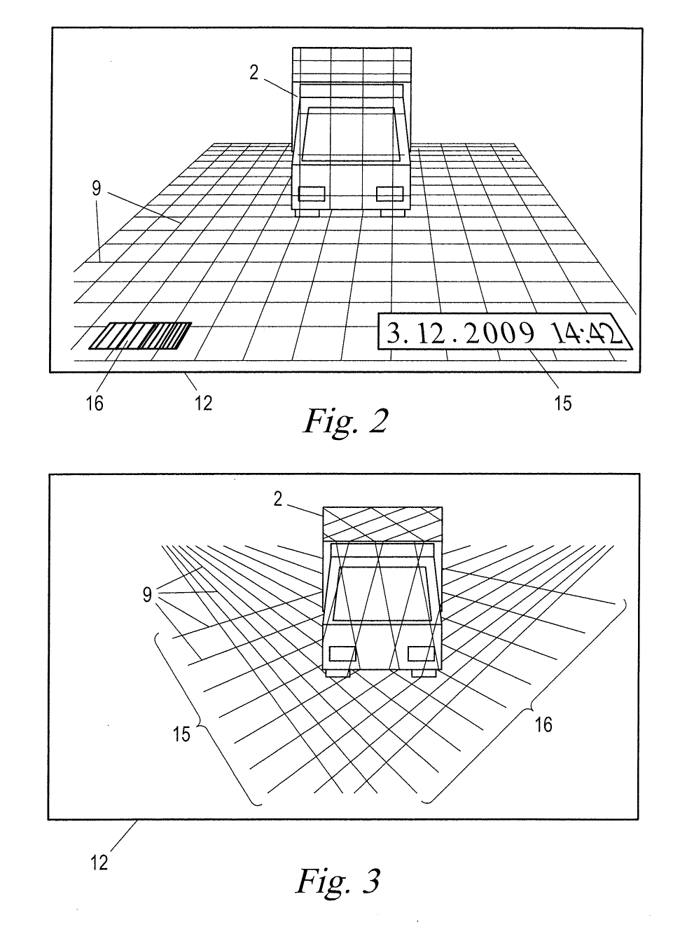

FIG. 1 shows a device 1 for classifying vehicles 2 on a roadway 3. The device 1 has a sensor 4, which operates according to the light-section procedure, is mounted on a bridge girder 5 spanning the roadway 3 and is connected to an evaluation unit 6. The sensor 4 comprises a light pattern projector 7, which projects a pattern of light 9 onto the roadway 3 from a first location—here an upper girder 8 of the bridge 5—and also a camera 10, which records an image 12 of the projected pattern of light 9 from a second location—here a lower girder 11 of the bridge 5—, as is shown by way of example in FIGS. 2 and 3. From distortions of the pattern of light 9 in the image 12, as occur as a result of the surface relief of a vehicle 2 from the viewing angle of the camera 8 different from the direction of light projection, the evaluation unit 6 determines the surface contour of the vehicle 2 and generates classification data 13 of the vehicle 2, e.g. its size, number of axles etc., therefrom.

The pattern of light 9 can be a single bar of light (“line” of light), a group of parallel bars of light (“fringes” of light, “fringe projection”) as well as a grid of light, as shown in FIG. 2. As can be seen from FIG. 2, the pattern of light 9 can consist of a grid of lines of light respectively spaced 1 m, for example, so that a size classification in the metre range can already be conducted by merely counting the grid intersection points projected onto a vehicle 2.

Other types of patterns of light 9 are also possible, e.g. the circular pattern 14 shown in plan view in FIG. 4. Circles provide a particularly simple to detect straight line when projected onto a cylindrical body, e.g. a tank truck, and viewed at a specific angle if the circle diameter corresponds to the cylindrical body diameter, from which the diameter of the tank truck, for example, can be determined.

An already existing traffic monitoring camera can preferably be used as camera 10. The light pattern projector 7 is preferably a laser emitter, the laser beams of which are passed through a lens of a diffraction grating in linear, fringe or grid form. The light pattern projector 7 can also be configured using high-power light-emitting diodes (LEDs). It is also possible to arrange more than one light pattern projector 7 at different positions, e.g. to illuminate the roadway 3 or the vehicle 2 from different angles in order to prevent shading.

FIG. 3 shows such a variant, in which a first set 15′ of parallel bars of light is projected onto the roadway 3 or vehicle 2 from one side by means of a first light pattern projector and a second set 16′ of parallel bars of light is projected from another side by means of a second light pattern projector. To enable the camera 10 and/or the evaluation unit 6 to correctly assign the bars of light in the image 12 to the light pattern projectors, the sets 15, 16 are emitted, for example, at different wavelengths in time-division multiplex operation or are provided with different modulations or codings, as is known in the art.

The light pattern projector or projectors 7 and the camera 10 can be arranged in any desired different positions so long as the projected pattern of light is recorded from a different direction to that of its projection.

The light pattern projector 7 can emit the light pattern 9 continuously, but also intermittently or in a pulsed manner, as required, e.g. if the presence of a vehicle 2 is detected on the roadway 3. A higher luminous power (“light flash”) can also be generated in the short term with such a pulsed operation in order to improve the image contrast in unfavourable ambient light conditions, e.g. bright sunshine.

The light-section sensor 4 can then also be applied to detect the mere presence of a vehicle 2 to activate further actions such as a subsequent classification by means of the device 1. In the simplest case, for such an activation only a single bar of light needs to be projected and its course in the image 12 monitored for a disturbance, e.g. a bend or break, which can be monitored with very simple image processing means.

As shown in FIG. 2, in addition to the light pattern 9 the light pattern projector 7 can also project a light marking 15, 16, which is held by the camera 10 in the image 12. The light marking can be a human-readable inscription 15 and/or a machine-readable code 16, e.g. a 1- or 2-dimensional bar code. As a result, the image 12 recorded by the camera 10 can be provided with a highly fake-proof identification e.g. of the location and the time of the image recording and/or other surrounding parameters, which can be of great assistance for purposes of proof in traffic monitoring and in the punishment for traffic offences.

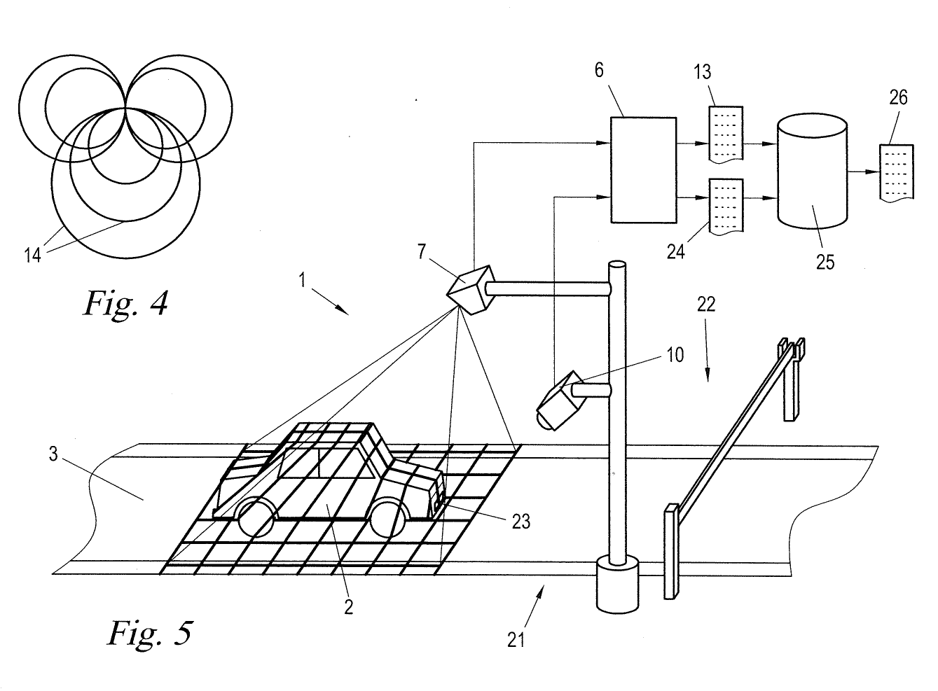

FIG. 5 shows an application of the device 1 of FIGS. 1 to 4 as part of an assembly 21 for checking the identity of vehicles 2, preferably at the entrance and exit 22 of a car park, e.g. a multistory car park.

The assembly 21 comprises a device 1 according to FIG. 1 with a light pattern projector 7 and a camera 10 for detecting the surface contour of a vehicle 2 and for determining classification data. In addition, the assembly 21 is fitted with a device for detecting a license plate 23 of the vehicle 2, which device can operate with the same hardware as device 1, i.e. with the camera 10 and the evaluation unit 6. For example, the evaluation unit 6 can contain a software module for optical character recognition (OCR) of the license plate 23.

In addition to the classification data 13, the evaluation unit 6 here also generates license plate data 24 for a vehicle 2 and links these data in a data bank 25 to identity data 26 of a vehicle 2. The identity data 26 therefore represent a type of fingerprint of a vehicle 2, since besides the license plate 23 they also contain further characteristics of the vehicle, e.g. its size, shape, number of axles etc.

On the basis of the identity data 26 identity checks can be conducted on vehicles 2, e.g. for plausibility whether the vehicle for which the license plate is permitted also actually comes into the class of vehicle indicated in the identity data. However, the assembly 21 can also determine whether two vehicles 2 appearing one after the other are identical or not by comparing the identity data 26.

An application of the assembly 21 is, for example, theft protection of vehicles in a car park e.g. in multistory car parks. The assembly 21 compares the identity data 26 of all entering and exiting vehicles and emits an alarm when irregularities in the identity data 26 occur, e.g. because license plates have been exchanged. In addition, an image of the vehicle can be taken with the camera 10, an exit barrier kept closed, etc. In this case, the assembly 21 is preferably set in operation by approach to the entrance or exit barriers. The light pattern projector 7 is preferably actuated in pulsed operation (light flash) for the light-section classification of the vehicle stopped in front of the barrier.

The invention is not restricted to the represented embodiments, but covers all variants and modifications that come within the scope of the attached claims.

What is claimed is:

1. A device for classifying objects on a roadway comprising:
a sensor configured to operate according to a light-section procedure, wherein the sensor is directed onto the roadway to detect the surface contour of an object; and
an evaluation unit coupled to the sensor configured to classify the object responsive to the detected surface contour.

2. The device according to claim 1, wherein the sensor comprises a light pattern projector, which projects a pattern of light from a first location onto the roadway; and a camera, which records the projected pattern of light from a second location and determines a surface contour of the object from distortions thereof.

3. The device according to claim 2, wherein the light pattern projector is configured to additionally project a light marking, and the camera is configured to record the light marking.

4. The device according to claim 3, wherein the light marking is a machine-readable code.

5. The device according to claim 2, wherein the sensor has at least two light pattern projectors at different first locations.

6. The device according to claim 2, wherein the light pattern projector is a laser or light-emitting diode emitter.

7. The device according to claim 2, wherein the camera is a traffic monitoring camera.

8. The device according to claim 1, wherein the object is a vehicle.

9. The device according to claim 2, wherein the pattern of light comprises a grid of light.

10. The device according to claim 4, wherein the machine-readable code is a bar code.

11. An assembly for checking the identity of vehicles comprising:
a classification device according to claim 1 to obtain classification data of a vehicle;
a device for license plate detection on vehicles to obtain license plate data of the vehicle;
a data bank for linking the classification and license plate data to identity data of the vehicle; and
an evaluation unit configured to determine that two vehicles are identical if their identity data are the same.

12. The assembly according to claim 11, wherein the classification device and the device for license plate detection use a joint camera.

13. The assembly according to claim 11, further comprising means for monitoring the entrance and exit of a car park, and a display for displaying data when the identity data of an exiting vehicle differ from the identity data stored in the data bank of a vehicle entered previously with a same license plate data.

14. A method for classifying objects on a roadway comprising:
projecting a pattern of light from a first location onto the roadway;
recording the projected pattern of light from a second location to detennine a surface contour of the object from distortions of the pattern of light; and
classifying the object on the basis of the detected surface contour.

15. The method according to claim 14, further comprising projecting a light marking in addition to the pattern of light, and recording the light marking.

16. The method according to claim 15, wherein the light marking is a machine-readable code.

17. The method according to claim 14, wherein the pattern of light and the optional light marking are recorded with a traffic monitoring camera.

18. A method for checking the identity of vehicles, comprising:
obtaining classification data of a first vehicle according to the method of claim 14;
detecting license plate data of the first vehicle; and
linking the classification data and license plate data to obtain identity data of the first vehicle,
obtaining classification data of a second vehicle according to the method of claim 14;
detecting license plate data of the second vehicle;
linking the classification and license plate data to obtain identity data of the second vehicle; and
recognising the first vehicle and the second vehicle as identical if their identity data are the same.

19. The method according to claim 18, further comprising activating an alarm if the identity data of an existing vehicle differ from the identity data of a vehicle with the same license plate data which entered previously.

20. The method according to claim 16, wherein the machine-readable code is a bar code.
